(19) United States
(12) Patent Application Publication
(10) Pub. No.: US 2019/0082499 A1
(43) Pub. Date: Mar. 14, 2019

(54) COMMUNICATION SYSTEM, RELAYING APPARATUS, CONTROL METHOD, AND PROGRAM

(71) Applicant: NEC CORPORATION, Tokyo (JP)

(72) Inventors: Fumihito MIYAZAWA, Tokyo (JP); Yuki NAKANISHI, Tokyo (JP); Yasuhiro WATANABE, Tokyo (JP)

(73) Assignee: NEC CORPORATION, Tokyo (JP)

(21) Appl. No.: 15/765,614

(22) PCT Filed: Oct. 4, 2016
(86) PCT No.: PCT/JP2016/079385

§ 371 Date: Apr. 3, 2018

(30) Foreign Application Priority Data
Oct. 5, 2015 (JP) 2015-197321

(51) Int. Cl. H04W 88/16; H04W 4/14; H04W 88/18; H04W 8/18; H04W 8/26

(52) U.S. Cl. CPC H04W 88/16; H04W 4/14; H04W 8/26; H04W 8/18; H04W 88/18

(57) ABSTRACT

A communication system includes: a service control apparatus that is provided in a first network in which user terminals communicate via a wireless base station and that distributes messages to the user terminals; a server that is provided in a second network for allowing user terminals to communicate without the mediation of a wireless base station and that communicates with the user terminals via the second network; and a relaying apparatus that is connected to the service control apparatus and that relays messages transmitted and received between user terminals in the first network and messages transmitted and received between user terminals in the first network and user terminals in the second network.

### TECHNICAL FIELD

The present invention relates to a communication system, a relaying apparatus, a control method, and a program.

### BACKGROUND ART

In a portable telephone network, user terminals (UE: User Equipment) are capable of connection with the portable telephone network by communicating with a wireless base station and can receive various services that are offered by way of the portable telephone network. 3G (Third Generation Mobile Communication Network) and LTE (Long Term Evolution) are known as portable telephone networks.

Services that are offered to UE by way of a portable telephone network include, for example, SMS (Short Message Service). SMS is a service that allows the transmission and reception of messages (SMS messages) between UE by way of the network and is used, for example, to verify whether or not conditions are safe at the time of a disaster. In SMS, a telephone number is used to specify the UE that transmit and receive the SMS messages.

A configuration for offering SMS to UE that are accommodated in a portable telephone network is described in, for example, Patent Document 1. Patent Document 1 proposes a configuration equipped with a GSN (GPRS (General Packet Radio Service) support node) for communicably connecting with UE that are accommodated in a portable telephone network (3G network) and IMS (IP Multimedia Subsystems). An IMS is one core network that constitutes a portable telephone network made up of a device group for offering telephone services or multimedia services to each UE on an IP (Internet Protocol) base. An SMSC (Short Message Service Center) that controls the distribution of SMS messages by way of an IPSMGW (IP Short Message Gateway) is connected to an IMS. SMS messages that are transmitted from UE are transferred to an SMSC by way of the IMS of the portable telephone network that accommodates the UE that is the transmission origin of the messages and the IPSMGW. The SMSC transmits the received SMS messages to the IPSMGW of the portable telephone network that accommodates the UE that are the transmission destinations of the messages and transfers the SMS messages from the IPSMGW to the transmission-destination UE by way of an IMS.

As described above, UE must be able to communicate with a portable telephone network by way of a wireless base station in order to transmit and receive SMS messages. As a result, when UE are present in an area in which communication with a wireless base station is not possible, or when the device that constitutes the portable telephone network breaks down due to a disaster and UE are unable to connect to the portable telephone network, the UE are no longer able to transmit and receive SMS messages.

Networks other than portable telephone networks that enable communication among UE are known. Examples of such networks include an IP (Internet Protocol) network in which UE perform wireless communication directly or via access points such as wireless LAN (Local Area Network) routers. In networks of this type, UE are able to transmit and receive messages with other UE that are present in the vicinity without the mediation of a wireless base station of a portable telephone network.

Configurations for offering SMS to UE that are accommodated in an IP network that is not a portable telephone network are proposed in, for example, Patent Documents 2 and 3. Patent Documents 2 and 3 propose configurations in which a network is equipped with a PDG (Packet Data Gateway) for communicably connecting IMS and UE that are accommodated in a wireless LAN. A PDG is a device that relays packets that are transmitted and received between an IMS and a wireless LAN.

As described above, when UE in a portable telephone network cannot be connected to the portable telephone network due to the breakdown of a device that makes up the portable telephone network as the result of, for example, a disaster, a communication disorder occurs in which messages cannot be transmitted or received. A communication system is therefore sought that can ensure communication means even at the time of a disaster and reduce the occurrence of communication disorders. As one example of this type of communication system, a communication system is considered in which a portable telephone network is combined with another IP network that is not a portable telephone network.

As described above, in an IP network that is not a portable telephone network, UE can transmit and receive messages with other UE without the mediation of the wireless base station of a portable telephone network. As a result, UE can transmit and receive messages with UE in the vicinity even when unable to connect to the portable telephone network.

However, in an IP network that is not a portable telephone network, the UE that can transmit and receive messages are limited to UE that are in proximity to each other. A configuration is thus considered in which UE use an IP network that is not a portable telephone network to distribute messages when unable to connect with a portable telephone network and use a portable telephone network to distribute messages when able to connect to the portable telephone network. In such a configuration, UE that are unable to connect with the portable telephone network are able to transmit and receive messages with UE that are able to connect to the portable telephone network. For example, in the communication system that is described in the above-described Patent Documents 2 and 3, UE that are accommodated in a wireless LAN are able to communicate with an IMS by way of a PDG and are therefore able to transmit and receive SMS messages by way of the IMS even when the UE are unable to communicate with a wireless base station.

Nevertheless, an IMS is one core network provided in the above-described type of portable telephone network. As a result, when considering the use of SMS in a disaster, an IMS that is a core network of a portable telephone network is preferably not interposed between an IP network that is not a portable telephone network and the above-described SMSC.

### RELATED ART DOCUMENTS

### Patent Documents

Patent Document 1: JP 2009-506590 A
Patent Document 2: JP 2006-525762 A
Patent Document 3: JP 2008-523732 A

### SUMMARY

An example object of the present invention is to provide a communication system, a relaying apparatus, a control method, and a program that, without the interposition of an IMS, enable the transmission and reception of messages between UE that are unable to connect to a portable telephone network and UE that are able to connect to the portable telephone network.

A communication system according to an example aspect of the present invention for achieving the above-described object comprising:

a service control device that is provided in a first network in which user terminals perform communication by way of a wireless base station and that distributes messages to the user terminals;

a server that is provided in a second network that differs from the first network and that transmits and receives the messages with the user terminals by way of the second network in which the user terminals communicate without the mediation of the wireless base station; and

a relaying apparatus that is connected to the service control device and that relays messages that are transmitted and received between user terminals in the first network as well as messages that are transmitted and received between user terminals in the first network and user terminals in the second network.

A relaying apparatus according to an example aspect of the present invention comprising:

a first communication unit that communicates with a service control device that is provided in a first network in which user terminals perform communication by way of a wireless base station and that distributes messages to the user terminals;

a second communication unit that communicates with a server that is provided in a second network that differs from the first network and that transmits and receives the messages with the user terminals by way of the second network in which the user terminals communicate without the mediation of the wireless base station; and

a control unit that relays messages that are transmitted and received between user terminals in the first network by way of the service control device as well as messages that are transmitted and received between user terminals in the first network and user terminals in the second network by way of the service control device.

A control method according to an example aspect of the present invention is a control method of a relaying apparatus that includes: a first communication unit that communicates with a service control device that is provided in a first network in which user terminals perform communication by way of a wireless base station and that distributes messages to the user terminals; and a second communication unit that communicates with a server that is provided in a second network that differs from the first network that transmits and receives the messages with the user terminals by way of the second network in which the user terminals communicate without the mediation of the wireless base station; the control method comprising steps of:

relaying messages that are transmitted and received between user terminals in the first network by way of the service control device; and

relaying messages that are transmitted and received between user terminals in the first network and user terminals in the second network by way of the service control device.

A program according to an example aspect of the present invention is for causing a computer to execute processes of:

communicating with a service control device that is provided in a first network in which user terminals perform communication by way of a wireless base station and that distributes messages to the user terminals;

communicating with a server that is provided in a second network that differs from the first network and that transmits and receives the messages with the user terminals by way of the second network in which user terminals communicate without the mediation of the wireless base station;

relaying messages that are transmitted and received among user terminals in the first network by way of the service control device; and

relaying messages that are transmitted and received between user terminals in the first network and user terminals in the second network by way of the service control device.

### BRIEF DESCRIPTION OF THE DRAWINGS

FIG. 1 is a block diagram showing an example of the configuration of the communication system of the present invention.

FIG. 2 is a block diagram showing an example of the configuration of the server shown in FIG. 1.

FIG. 3 is a block diagram showing an example of the configuration of the relaying apparatus shown in FIG. 1.

FIG. 4 is a schematic view showing the state of the transmission of a message from UE (X) to UE (Y) that are located in the IP network shown in FIG. 1.

FIG. 5 is a schematic view showing an example of the format of a message that is created by UE (X) shown in FIG. 4.

FIG. 6 is a schematic view showing the state of the transmission of a message from UE (Y) to UE (X) that are located in IP network shown in FIG. 1.

FIG. 7 is a schematic view showing an example of the format of a message created by UE (Y) shown in FIG. 6.

FIG. 8 is a schematic view showing the state of the transmission of a message from UE (X) located in the portable telephone network shown in FIG. 1 to UE (Z) located in a portable telephone network.

FIG. 9 is a schematic view showing the state of the transmission of a message from UE (X) located in the IP network shown in FIG. 1 to UE (Z) located in a portable telephone network.

FIG. 10 is a schematic view showing an example of the format of a message created by UE (X) shown in FIG. 8.

FIG. 11 is a schematic view showing an example of the format of a message converted by the relaying apparatus shown in FIG. 8 from the message shown in FIG. 10.

FIG. 12 is a schematic view showing an example of the format of a message created by UE (X) shown in FIG. 9.

FIG. 13 is a schematic view showing the state of transmission of a message from UE (Z) located in the portable telephone network shown in FIG. 1 to UE (X) located in a portable telephone network.

FIG. 14 is a schematic view showing the state of transmission of a message from UE (Z) located in the portable telephone network shown in FIG. 1 to UE (X) located in an IP network.

FIG. 15 is a schematic view showing an example of the format of a message created by the IPSMGW shown in FIG. 13.

FIG. 16 is a schematic view showing an example of the format of a message that has been converted from the message shown in FIG. 15 by the relaying apparatus shown in FIG. 13.

FIG. 17 is a schematic view showing an example of the format of a message that has been converted from the message shown in FIG. 15 by the relaying apparatus shown in FIG. 14.

FIG. 18 is a sequence diagram showing the operation when a message is transmitted from UE (X) located in the IP network shown in FIG. 1 to UE (Y).

FIG. 19 is a sequence diagram showing the operation when a message is transmitted from UE (Y) located in the IP network shown in FIG. 1 to UE (X).

FIG. 20 is a sequence diagram showing the operation when a message is transmitted from UE (X) located in the portable telephone network shown in FIG. 1 to UE (Z).

FIG. 21 is a sequence diagram showing the operation when a message is transmitted from UE (X) located in the IP network shown in FIG. 1 to UE (Z).

FIG. 22 is a sequence diagram showing the operation when a message is transmitted from UE (Z) located in the portable telephone network shown in FIG. 1 to UE (X) that is located in a portable telephone network.

FIG. 23 is a sequence diagram showing the operation when a message is transmitted from UE (Z) located in the portable telephone network shown in FIG. 1 to UE (X) located in an IP network.

### EXAMPLE EMBODIMENT

The present invention is next described with reference to the accompanying drawings.

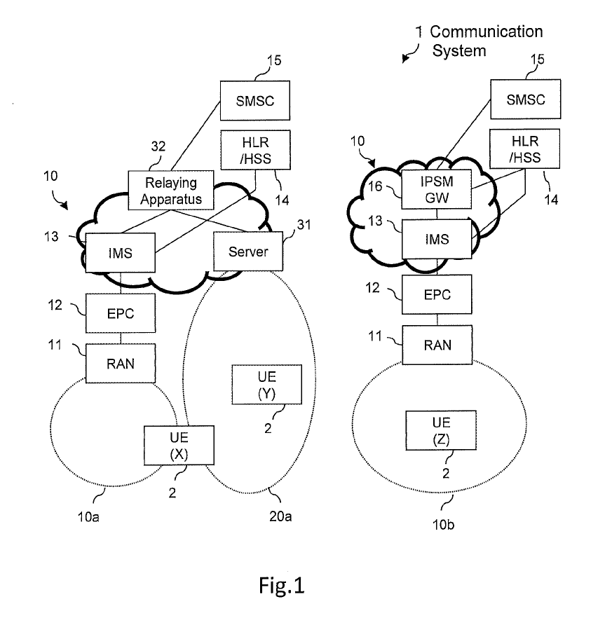

FIG. 1 is a block diagram showing an example of the configuration of the communication system of the present invention.

The communication system shown in FIG. 1 is equipped with, as the first network, portable telephone network 10 in which UE 2 performs communication by way of a wireless base station; and, as the second network, an IP network that is not portable telephone network 10 (hereinbelow referred to as simply “IP network”) 20.

Actual examples of portable telephone network 10 include a wireless communication network based on a communication method such as 3G or LTE. Actual examples of IP network 20 include wireless communication networks made up of communication methods such as WiFi (Wireless Fidelity) (Registered Trademark), WiFi-Direct, Bluetooth (Registered Trademark), and LTE-Direct. When a plurality of UE 2 are accommodated in IP network 20, each UE 2 may transmit and receive messages with other UE by direct communication, i.e., by an ad hoc method. UE 2 is assumed to have at least one of the following capabilities: the capability to perform communication by way of a wireless base station (connecting to portable telephone network 10); and the capability to perform communication via IP network 20.

As shown in FIG. 1, communication system 1 is equipped with RAN (Radio Access Network) 11, EPC (Evolved Packet Core) 12, IMS 13, HLR/HSS (Home Location Register/Home Subscriber Server) 14, SMSC 15, IPSMGW 16, server 31, and relaying apparatus 32.

RAN 11 is a wireless access network that includes a wireless base station that performs wireless communication with UE 2 and that forms a predetermined communication area. EPC 12 is a core network that is made up of a device group for realizing a packet exchange method of an IP base in portable telephone network 10.

IMS 13 is a core network composed of a device group for providing to each UE 2 telephone services or multimedia services by an IP base.

HLR/HSS 14 is a management device that manages the location of UE 2. HLR/HSS 14 saves subscriber information of UE 2 and the positional information (the area in which UE 2 are located) of these UE 2 in association.

SMSC 15 controls the distribution of messages (SMS messages) that are transmitted and received as SMS among UE 2. SMSC 15 is an example of a service control device. SMSC 15 is provided in portable telephone network 10.

IPSMGW 16 is a network apparatus that connects IMS 13 and SMSC 15 for which the communication protocols differ and provides SMS to UE that use portable telephone network 10.

Server 31 is connected to relaying apparatus 32 by way of the network and relays messages that are transmitted and received among UE 2. Server 31 transmits and receives messages by way of access points (not shown in the figure) among UE 2 that are capable of wireless communication with the access points.

Relaying apparatus 32 is connected to server 31, IMS 13, HLR/HSS 14, and SMSC 15 by way of the network. When transmitting and receiving messages by way of server 31, relaying apparatus 32 is equipped with the capability of a gateway that switches distribution paths as well as the capability of IPSMGW 16. In other words, relaying apparatus 32 relays messages that are transmitted and received among UE 2 in portable telephone network 10 by way of SMSC 15 as well as messages that are transmitted and received between UE 2 in portable telephone network 10 and UE 2 in IP network 20 by way of SMSC 15. Relaying apparatus 32 is provided in a network that includes portable telephone network 10 and IP network 20, and IPSMGW 16 is provided in a network equipped only with portable telephone network 10.

When nodes of portable telephone network 10 that are connected to relaying apparatus 32 are shown in the following explanation, they will be noted as RAN 11a, EPC 12a, IMS 13a, HLR/HSS 14a, and SMSC 15a, and the portable telephone network will be noted as 10A. In addition, when nodes of portable telephone network 10 connected to IPSMGW 16 are shown, they will be noted as RAN 11b, EPC 12b, IMS 13b, HLR/HSS 14b, and SMSC 15b, and the portable telephone network will be noted as 10B. When these are shown consolidated, they are noted as RAN 11, EPC 12, IMS 13, HLR/HSS 14, SMSC 15 and portable telephone network 10. In addition, the communication area formed by RAN 11a is noted as 10a, the communication area formed by RAN 11b is noted as 10b, and the area in which UE 2 are able to communicate by server 31 is noted as 20a.

Although area 20a in which UE 2 are able to communicate by means of server 31 is depicted as being larger than areas 10a and 10b in which UE 2 are able to communicate by RAN 11 in FIG. 1, the size of these areas does not indicate the actual sizes of the communication areas.

The configurations of server 31 and relaying apparatus 32 are next described. The configurations of other nodes shown in FIG. 1 will be known to one of ordinary skill in the art and explanation is therefore here omitted.

The configuration of server 31 is first described.

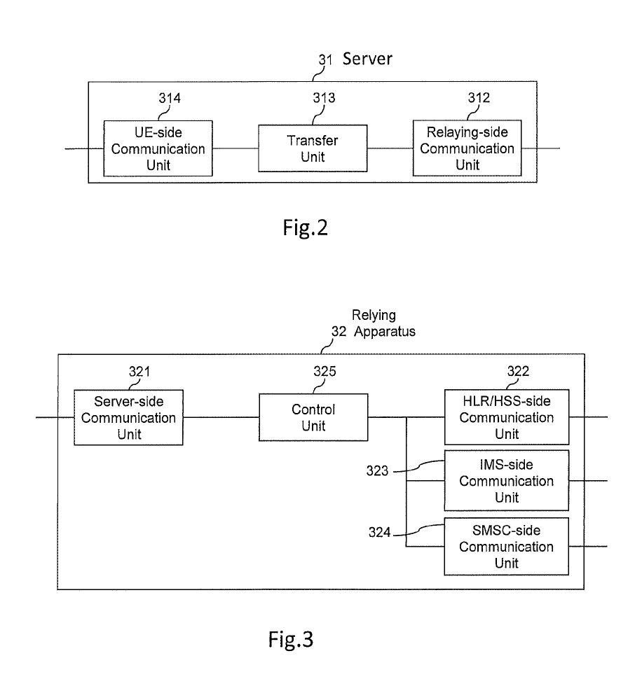

FIG. 2 is a block diagram showing an example of the configuration of the server shown in FIG. 1. As shown in FIG. 2, server 31 has relaying apparatus-side communication unit 312, transfer unit 313, and UE-side communication unit 314.

Relaying apparatus-side communication unit 312 performs communication with relaying apparatus 32. UE-side communication unit 314 performs communication with UE 2. Transfer unit 313, upon receiving a message from UE 2, transfers this message to another UE 2 or to relaying apparatus 32. Transfer unit 313 further, upon receiving a message from relaying apparatus 32 by way of relaying apparatus-side communication unit 312, transfers this message to UE 2.

The configuration of relaying apparatus 32 is next described.

FIG. 3 is a block diagram showing an example of the configuration of the relaying apparatus shown in FIG. 1.

As shown in FIG. 3, relaying apparatus 32 has server-side communication unit 321, HLR/HSS-side communication unit 322, IMS-side communication unit 323, SMSC-side communication unit 324, and control unit 325.

Server-side communication unit 321 performs communication with server 31 by means of a predetermined protocol (for example, IP).

HLR/HSS-side communication unit 322 performs communication with HLR/HSS 14a by means of a predetermined protocol (for example, MAP (Mobile Application Part). IMS-side communication unit 323 performs communication with IMS 13a by means of a predetermined protocol (for example, IP).

SMSC-side communication unit 324 performs communication with SMSC 15a by means of a predetermined protocol (for example, MAP).

Control unit 325, upon receiving a message from server 31 by way of server-side communication unit 321, transmits the message to SMSC 15a by way of SMSC-side communication unit 324. Alternatively, upon receiving a message from IMS 13a by way of IMS-side communication unit 323, control unit 325 transmits the message to SMSC 15a by way of SMSC-side communication unit 324. Upon receiving a message from SMSC 15a by way of SMSC-side communication unit 324, control unit 325 transmits the message to IMS 13a or server 31 by way of IMS-side communication unit 323 or server-side communication unit 321. Still further, upon receiving management information that contains subscriber information or positional information of UE 2 by way of server-side communication unit 321, control unit 325 transmits the management information to HLR/HSS 14a by way of HLR/HSS-side communication unit 322.

Server 31 and relaying apparatus 32 can be realized by an information processing device (a computer) that is equipped with, for example, a CPU (Central Processing Unit) that executes processing in accordance with a program, a memory device, various types of logical circuits, and a communication means for transmitting and receiving information by way of a network. Although FIG. 1 shows an example of a configuration separately equipped with server 31 and relaying apparatus 32, the functions of server 31 and the functions of relaying apparatus may also be realized by a single device.

An outline of the operation of communication system 1 of the present invention is next described using the accompanying drawings.

The operation is first described for a case of the transmission and reception of messages between UE located in IP network 20.

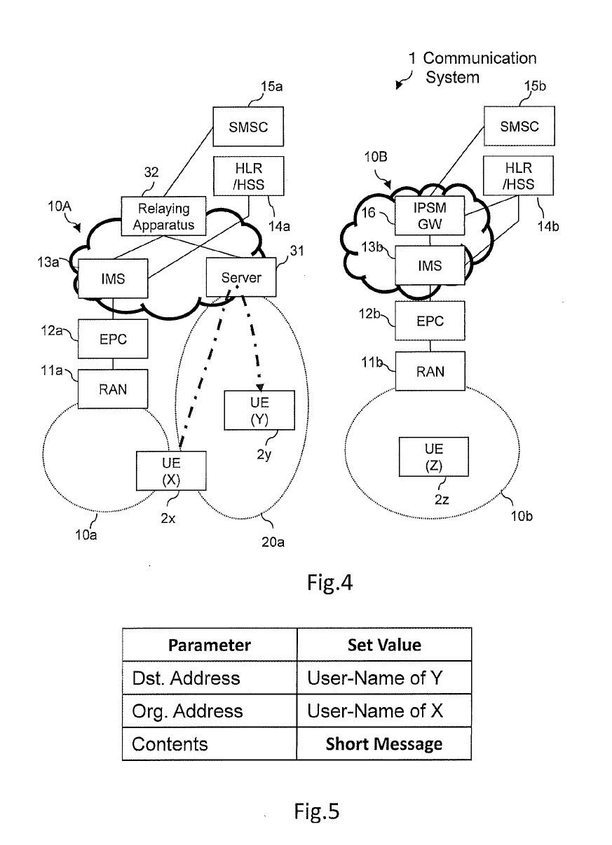

FIG. 4 is a schematic view showing the state of the transmission of a message to UE (Y) from UE (X) located in IP network shown in FIG. 1. FIG. 5 is a schematic view showing an example of the format of a message created by UE (X) shown in FIG. 4.

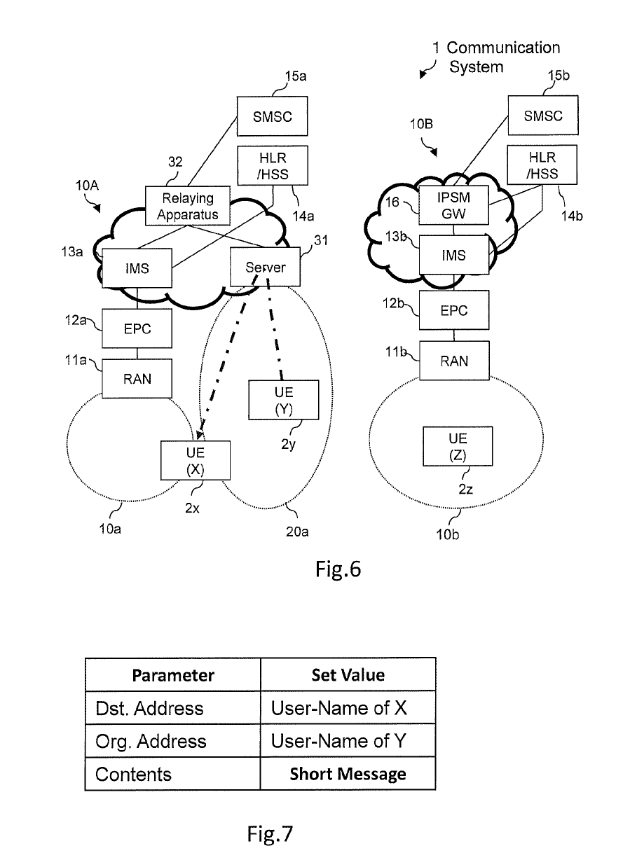

FIG. 6 is a schematic view showing the state of the transmission of a message to UE (X) from UE (Y) located in the IP network shown in FIG. 1. FIG. 7 is a schematic view showing an example of the format of a message created by UE (Y) shown in FIG. 6.

When transmitting a message to UE (Y) 2y as shown in FIG. 4, UE (X) 2x creates a message (SMS message) that is to be transmitted to UE (Y) 2y in accordance with the format shown in FIG. 5.

As shown in FIG. 5, the message created by UE (X) 2x contains Dst. Address (Dst. Address) portion, Org. Address (Org. Address) portion, and Contents portion. When UE (X) 2x transmits a message to UE (Y) 2y, UE (X) 2x sets the user-name of UE (Y) 2y that is the transmission destination of the message (the User-Name of Y) in the Dst.Address portion. In addition, UE (X) 2x sets the user-name of UE (X) 2x that is the transmission origin of the message (the User-Name of X) in the Org.Address portion. The text (short message) of the message is stored in the Contents portion.

The user-names are for identifying each UE 2 located in IP network 20 and are set in advance and registered in server 31. The user-names may be of any type as long as they are able to identify each UE 2. For example, the user-names may employ the individual identification information of UE 2, user ID (identification), or telephone numbers.

As shown in FIG. 4, UE (X) 2x transmits the generated message to server 31. Because the transmission destination of the message received from UE (X) 2x is UE (Y) 2y, server 31 transmits this message to UE (Y) 2y.

On the other hand, when transmitting a message from UE (Y) 2y to UE (X) 2x as shown in FIG. 6, UE (Y) 2y sets the user-name of UE (X) 2x that is the transmission destination of the message (User-Name of X) in the Dst.Address portion. UE (Y) 2y further sets the user-name of UE (Y) 2y that is the transmission origin of the message (User-Name of Y) in the Org.Address portion. The text of the message (short message) is stored in the Contents portion.

As shown in FIG. 6, UE (Y) 2y transmits the message that was generated to server 31. Because the transmission destination of the message received from UE (Y) 2y is UE (X) 2x, server 31 transmits this message to UE (X) 2x.

In this way, messages can be transmitted and received between UE 2 in IP network 20 that is not portable telephone network 10A via server 31.

The operation when messages are transmitted and received between UE (X) 2x and UE (Z) 2z that uses portable telephone network 10 is next described using the accompanying drawings.

When transmitting and receiving messages without using portable telephone network 10A, UE (X) 2x is assumed to be positionally registered in HLR/HSS 14a via server 31 and relaying apparatus 32. The method of the positional registration of UE 2 is described in, for example, JP 2014-144360A for which application was previously submitted by the present inventors.

The operation when a message is to be transmitted from UE (X) 2x to UE (Z) 2z is first described.

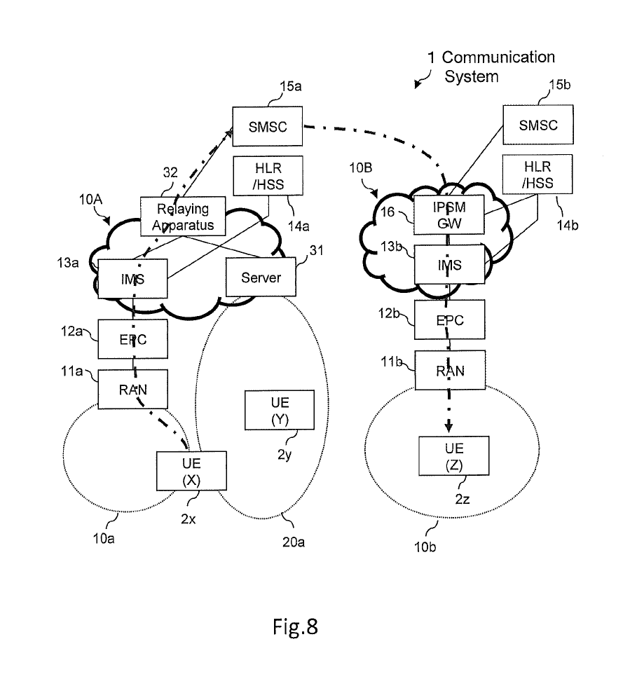

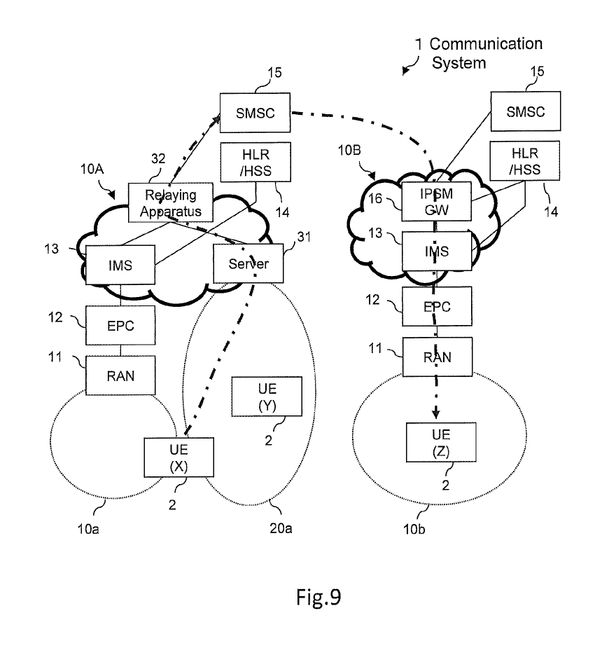

When a message is to be transmitted from UE (X) 2x to UE (Z) 2z, the message is in one case transmitted by way of portable telephone network 10A that includes RAN 11a, EPC 12a, and IMS 13a as shown in FIG. 8, and in another case transmitted by way of server 31 as shown in FIG. 9.

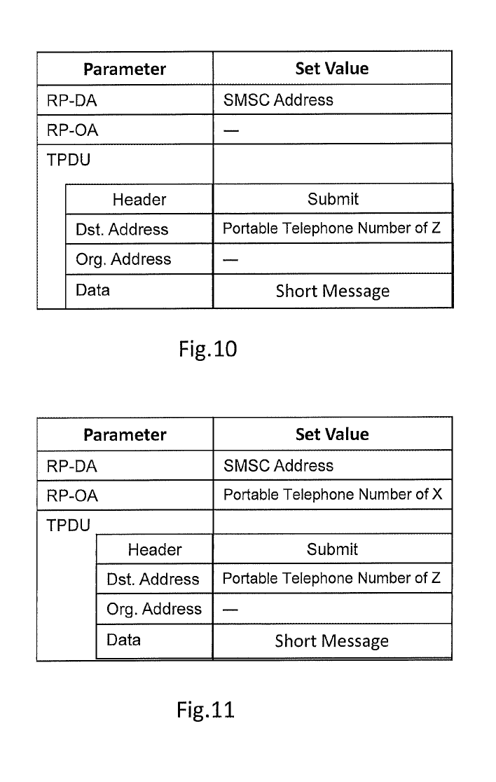

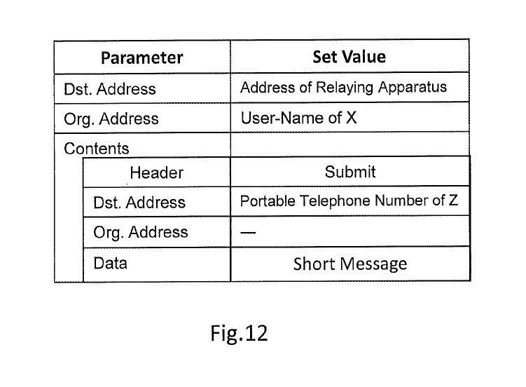

FIG. 8 is a schematic view showing the state of transmission of a message from UE (X) located in the portable telephone network to UE (Z) located in a portable telephone network shown in FIG. 1. FIG. 9 is a schematic view showing the state of transmission of a message from UE (X) located in the IP network to UE (Z) located in a portable telephone network shown in FIG. 1. FIG. 10 is a schematic view showing an example of the format of a message created by UE (X) shown in FIG. 8. FIG. 11 is a schematic view showing an example of the format of a message that is converted from the message shown in FIG. 10 by the relaying apparatus shown in FIG. 8. FIG. 12 is a schematic view showing an example of the format of a message created by UE (X) shown in FIG. 9.

When transmitting a message to UE (Z) by way of portable telephone networks 10A and 10B as shown in FIG. 8, UE (X) creates a message (SMS message) in the format shown in FIG. 10 and transmits the message to RAN 11. When transmitting a message from UE (X) 2x to UE (Z) 2z by way of portable telephone networks 10A and 10B as shown in FIG. 10, the message that UE (X) 2x creates includes an RP-DA (Relay Layer Protocol-Destination Address) portion, an RP-OA (Relay Layer Protocol-Origination Address) portion, and a TPDU (Transmission Protocol Data Portion) portion. The TPDU portion is provided with a Header portion, a Dst.Address (Dst.Address) portion, an Org.Address (Org.Address) portion, and a Data portion.

When UE (X) 2x is to transmit a message to UE (Z) 2z by way of portable telephone network 10, UE (X) 2x sets the SMSC address that is the address in the network of SMSC 15a in the RP-DA portion, as shown in FIG. 10. Further, UE (X) 2x sets “Submit” in the Header portion of the TPDU portion. UE (X) 2x also sets the portable telephone number of UE (Z) 2z that is the transmission destination of the message in the Dst.Address portion of the TPDU portion. Finally, UE (X) 2x stores the text of the message (short message) in the Data portion of the TPDU portion. The RP-DA portion and the Org.Address portion of the TPDU portion are each set to “unset (−).”

As shown in FIG. 8, UE (X) 2x transmits the generated message to SMSC 15a by way of RAN 11a, EPC 12a, IMS 13a, and relaying apparatus 32. At this time, relaying apparatus 32 converts the RP-DA portion of the message received from IMS 13a to a portable telephone number that corresponds to UE (X) 2x that is the transmission destination of the message as shown in FIG. 11 and transmits to SMSC 15a.

SMSC 15a transmits the message received from relaying apparatus 32 to IPSMGW 16 that takes as the object of management the communication area that accommodates UE (Z) 2z on the basis of the portable telephone number of UE (Z) 2z that is set in the Dst.Address portion of the TPDU portion. IPSMGW 16 transmits the message that was received from SMSC 15a to UE (Z) 2z by way of IMS 13b, EPC 12b, and RAN 11b in portable telephone network 10B.

On the other hand, when UE (X) 2x fails to connect with portable telephone network 10A and transmits the message to UE (Z) 2z by way of server 31 as shown in FIG. 9, UE (X) 2x creates a message such as shown in FIG. 12 (SMS message) and transmits to server 31.

As shown in FIG. 12, when transmitting a message from UE (X) 2x to UE (Z) 2z by way of server 31, the Dst.Address (Destination Address) portion, Org.Address (Origination Address) portion, and Contents portion are contained in the message created by UE (X) 2x. The Contents portion is provided with a Header portion, a Dst.Address portion, an Org.Address portion, and a Data portion.

When UE (X) 2x transmits a message to UE (Z) 2z by way of server 31, UE (X) 2x sets the address in the network of relaying apparatus in the Dst.Address portion as shown in FIG. 12. In addition, UE (X) 2x sets the user-name of UE (X) 2x that is the transmission origin of the message (the User-Name of X) in the Org.Address portion. In addition, UE (X) 2x sets “Submit” in the Header portion of the Contents portion and sets the portable telephone number of UE (Z) 2z that is the transmission destination of the message in the Dst.Address portion. Further, UE (X) 2x stores the text of the message (short message) in the Data portion of the Contents portion. The Org.Address portion of the Contents portion is set to “unset (−).”

As shown in FIG. 9, when the message generated by UE (X) 2x is transmitted to server 31, server 31 transfers this message to relaying apparatus 32 because the transmission destination of the message received from UE (X) 2x is relaying apparatus 32.

Relaying apparatus 32 converts the message received from server 31 to the message shown in FIG. 11. In other words, relaying apparatus 32 converts the Org.Address portion to the telephone number that corresponds to UE (X) 2x and converts the Dst.Address portion to the SMSC address of SMSC 15a. In addition, Relaying apparatus 32 converts the Contents portion to the TPDU (Transmission Protocol Data Portion) format. Relaying apparatus 32 transmits the message that follows conversion to SMSC 15a.

SMSC 15a transmits the message received from relaying apparatus 32 to IPSMGW 16 of portable telephone network 10B that accommodates the UE (Z) 2z on the basis of the portable telephone number of UE (Z) 2z that was set in the Dst.Address portion of the TPDU portion. IPSMGW 16 transmits the message that was received from SMSC 15a to UE (Z) 2z by way of IMS 13b, EPC 12b, and RAN 11b in portable telephone network 10B.

The operation when a message is transmitted from UE (Z) 2z to UE (X) 2x is next described with reference to the accompanying drawings.

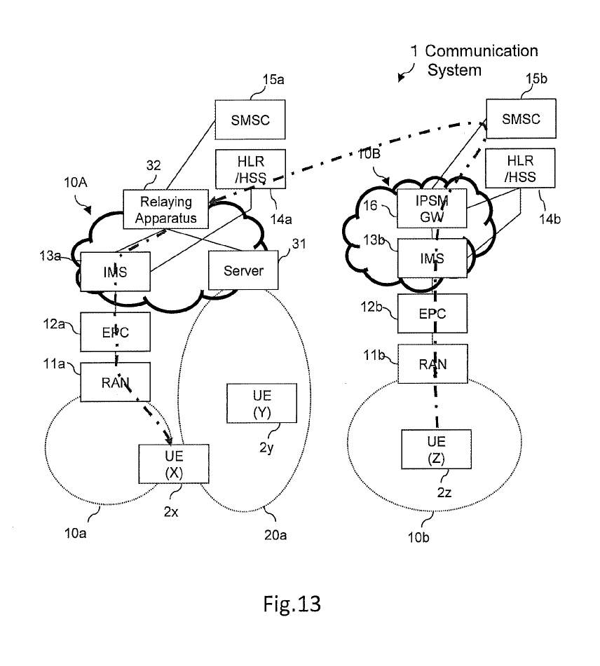

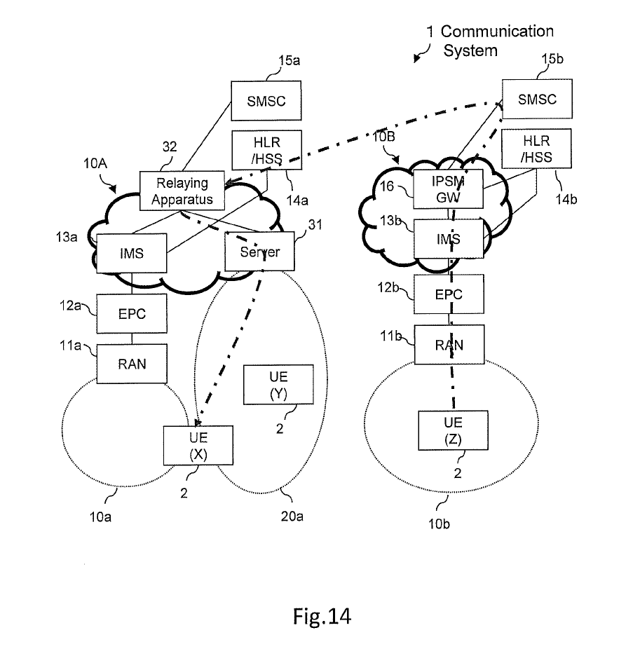

The transmission of a message from UE (Z) 2z to UE (X) 2x includes a case of transmission by way of portable telephone networks 10B and 10A as shown in FIG. 13 and a case of transmission by way of server 31 as shown in FIG. 14.

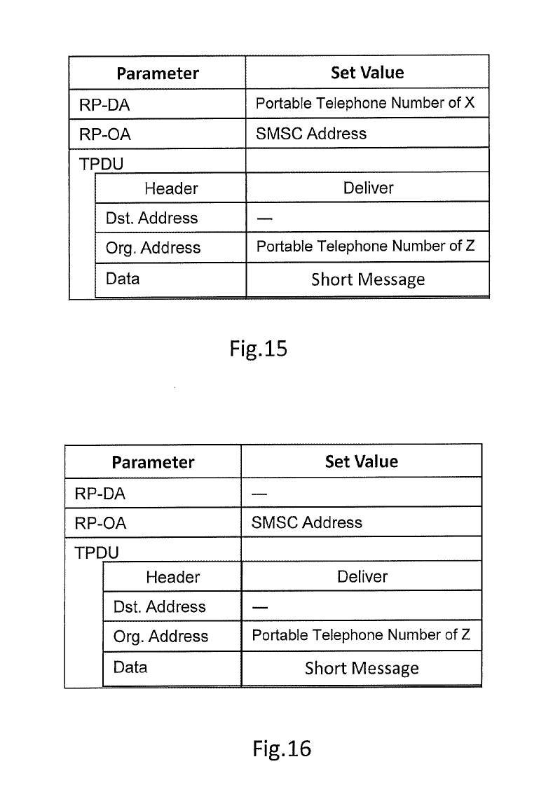

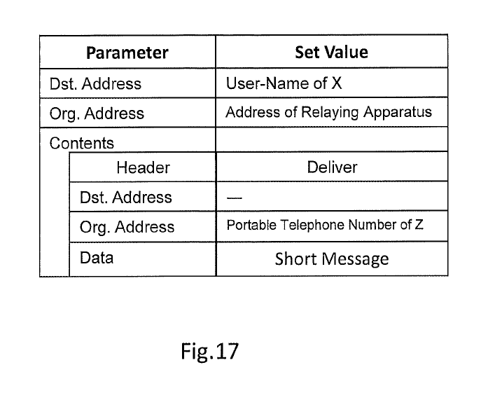

FIG. 13 is a schematic view showing the state of transmission of a message to UE (X) 2x from UE (Z) 2z located in the portable telephone network shown in FIG. 1. FIG. 14 is a schematic view showing the state of transmission of a message to UE (X) 2x located in IP network from UE (Z) 2z located in portable telephone network shown in FIG. 1. FIG. 15 is a schematic view showing an example of the format of a message created by IPSMGW shown in FIG. 13. FIG. 16 is a schematic view showing an example of the format of a message converted from the message shown in FIG. 15 by the relaying apparatus shown in FIG. 13. FIG. 17 is a schematic view showing an example of the format of a message converted from the message shown in FIG. 15 by the relaying apparatus shown in FIG. 14.

When a message is transmitted to UE (X) 2x by way of portable telephone networks 10B and 10A as shown in FIG. 13, UE (Z) 2z creates a message similar to UE (X) 2x shown in FIG. 10 and transmits the message to RAN 11b. However, UE (Z) 2z sets “Deliver” in the Header portion of the TPDU portion. In addition, UE (Z) 2z sets the portable telephone number of UE (X) 2x that is the transmission destination of the message in the RP-DA portion and sets the portable telephone number of UE (Z) 2z that is the transmission origin of the message in the Org.Address portion of the TPDU portion. The Dst.Address portion of the TPDU portion is “unset (−).”

The message generated by UE (Z) 2z is transmitted to IPSMGW 16 by way of RAN 11b, EPC 12b, and IMS 13b as shown in FIG. 13.

IPSMGW 16 converts the format of the message received from UE (Z) 2z to the format shown in FIG. 15 (sets the SMSC address in the RP-OA portion) and transmits the message to SMSC 15b.

Upon receiving the SMS message that takes UE (X) 2x as the transmission destination from IPSMGW 16, SMSC 15b refers to HLR/HSS 14a of portable telephone network 10 that accommodates that UE (X) 2x to identify the transmission (distribution) destination of that SMS message.

The identification information of relaying apparatus 32 that accommodates that UE (X) 2x is stored in HLR/HSS 14a in correspondence with the subscriber information of UE (X) 2x. As a result, SMSC 15b uses a predetermined protocol (for example, MAP) to both submit a request to relaying apparatus 32 to transmit the message that takes UE (X) 2x as the transmission destination and transmits the message to relaying apparatus 32.

Relaying apparatus 32, upon being requested from SMSC 15b to transmit the message that takes UE (X) 2x as the transmission destination, uses a predetermined protocol (for example, IP) to transmit the message to UE (X) 2x by way of IMS 13a, EPC 12a, and RAN 11a in portable telephone network 10A. At this time, relaying apparatus 32 converts the message received from SMSC 15b to the message shown in FIG. 16. In other words, the RP-DA portion is assumed to be “unset (−).”

On the other hand, when UE (X) 2x fails to connect with portable telephone network 10A, relaying apparatus 32 transmits the message to UE (X) 2x by way of server 31 as shown in FIG. 14. At this time, relaying apparatus 32 converts the message received from SMSC 15b from the format shown in FIG. 15 to the format shown in FIG. 17. In other words, the Dst.Address portion is converted to the user-name of UE (X) 2x that is the transmission destination of the message (the User-Name of X).

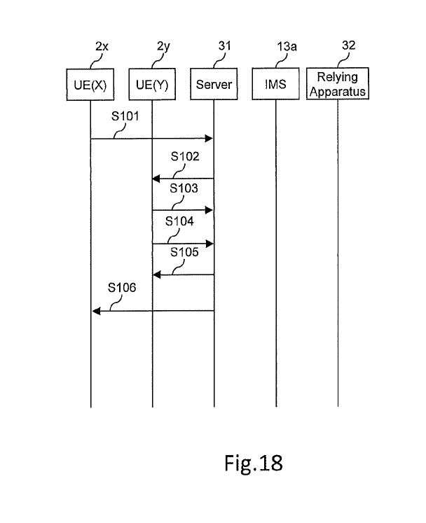

The details of the operation of communication system 1 of the present invention are next described using the sequence diagrams of FIGS. 18-23.

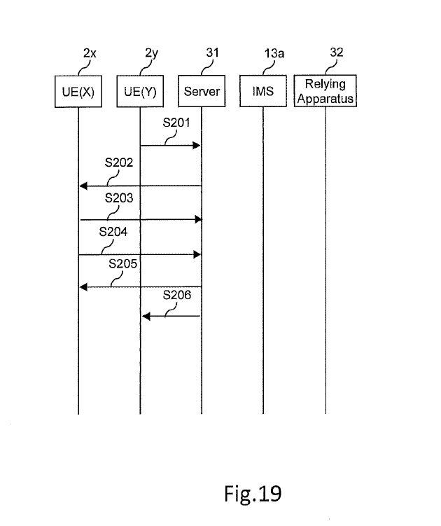

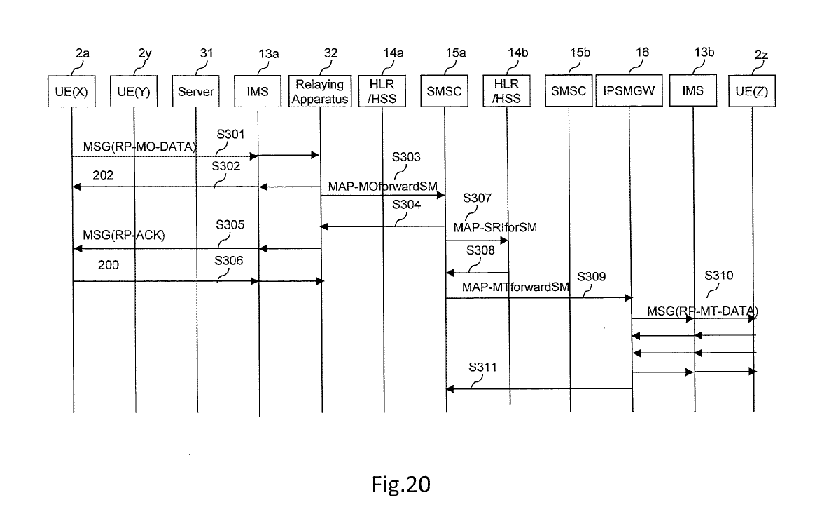

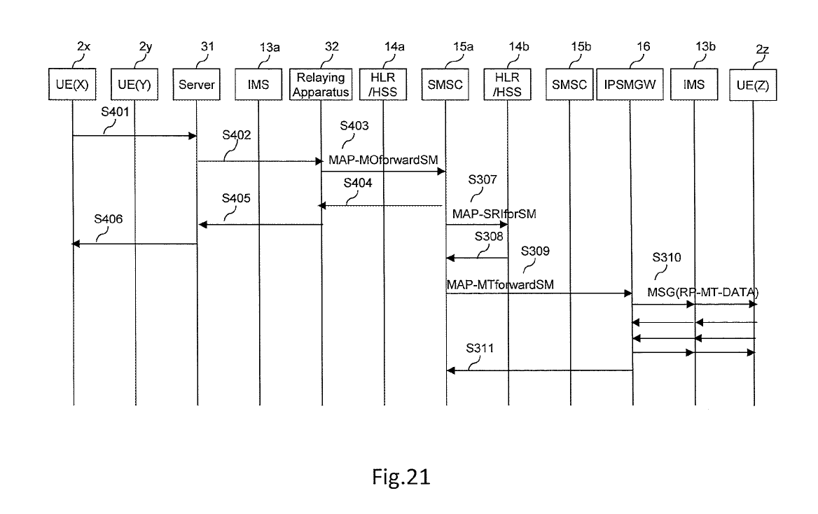

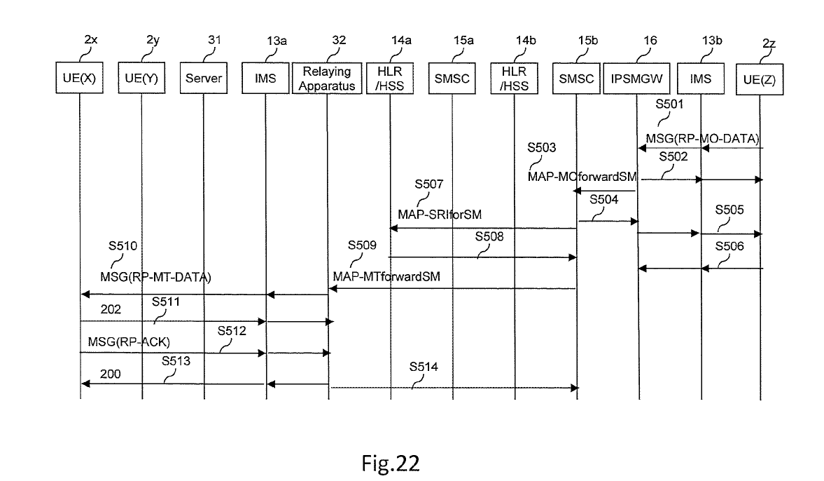

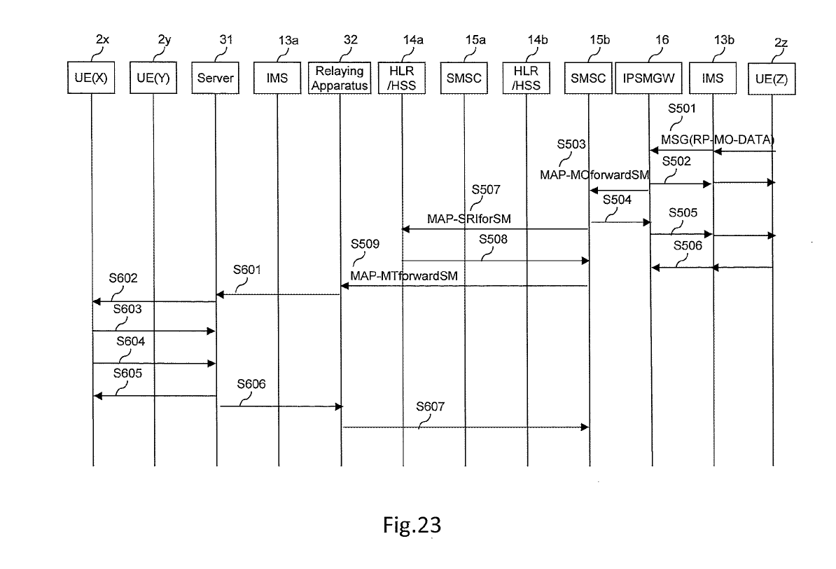

FIG. 18 is a sequence diagram that shows the operation when a message is transmitted to UE (Y) from UE (X) located in an IP network shown in FIG. 1. FIG. 19 is a sequence diagram showing the operation when a message is transmitted to UE (X) from UE (Y) located in the IP network shown in FIG. 1. FIG. 20 is a sequence diagram showing the operation when a message is transmitted to UE (Z) from UE (X) located in the portable telephone network shown in FIG. 1. FIG. 21 is a sequence diagram showing the operation when a message is transmitted to UE (Z) from UE (X) located in the IP network shown in FIG. 1. FIG. 22 is a sequence diagram showing the operation when a message is transmitted to UE (X) located in a portable telephone network from UE (Z) located in the portable telephone network shown in FIG. 1. FIG. 23 is a sequence diagram showing the operation when a message is transmitted to UE (X) located in an IP network from UE (Z) located in portable telephone network shown in FIG. 1.

The operation when transmitting a message between UE 2 in IP network 20 is first described using the accompanying drawings.

As shown in FIG. 18, when UE (X) 2x transmits a message to UE (Y) 2y, UE (X) 2x creates the message in the format shown in FIG. 5 and transmits the message to server 31 (Step S101). Server 31, upon receiving the message from UE (X) 2x, identifies the transmission destination of the message from the set value of the Dst.Address portion. Then, when transmitting the message in “Push” form, server 31 immediately transmits the message to UE (Y) 2y that is the transmission destination (Step S102). UE (Y) 2y, upon receiving the message from server 31, returns a reception response to server 31 (Step S103). On the other hand, in the case of transmitting the message in the “Pull” form, when server 31 receives a request to transmit the message from UE (Y) 2y (Step S104), server 31 transmits the message received from UE (X) 2x to UE (Y) 2y (Step S105). Upon completion of transmission of the message to UE (Y) 2y, server 31 transmits a message indicating this completion to UE (X) 2x (Step S106).

As shown in FIG. 19, when UE (Y) 2y transmits a message to UE (X) 2x, UE (Y) 2y creates a message in the format shown in FIG. 7 and transmits the message to server 31 (Step S 201). Server 31, upon receiving the message from UE (Y) 2y, identifies the transmission destination of the message from the set value of the Dst.Address portion. When transmitting the message in the “Push” form, server 31 immediately transmits the message to UE (X) 2x that is the transmission destination (Step S202). Upon receiving the message from server 31, UE (X) 2x returns a reception response to this message to server 31 (Step S203). On the other hand, in a case of transmitting the message in the “Pull” form, when server 31 receives a request to transmit the message from UE (X) 2x (Step S204), server 31 transmits the message received from UE (Y) 2y to UE (X) 2x (Step S205). Upon completing transmission of the message to UE (X) 2x, server 31 transmits a message indicating this completion to UE (Y) 2y (Step S206).

As shown in FIG. 20, when UE (X) 2x transmits a message to UE (Z) 2z by way of portable telephone networks 10A and 10B, UE (X) 2x transmits data (the message) to relaying apparatus 32 by short message service relay protocol (Step S301). More specifically, UE (X) 2x generates MSG (RP-MO-DATA) (Short Message Relay Layer Protocol-Mobile Oriented) that is a message composed in the format shown in FIG. 10 and transmits this MSG (RP-MO-DATA) to relaying apparatus 32 by way of IMS 13a.

Relaying apparatus 32, having received MSG (RP-MO-DATA) that takes UE (Z) 2z as the transmission destination from IMS 13a, returns “202 (Accepted),” which is a SIP message indicating that the request has been received but that the process has not been completed, to UE (X) 2x by way of IMS 13a (Step S302). In addition, relaying apparatus 32 transmits MAP-MOforwardSM (MAP-Mobile Originated Point-to-Point Forward Short Message), which is a message made up from the format shown in FIG. 11, to SMSC 15a (Step S303).

SMSC 15a, upon receiving the MAP-MOforwardSM, transmits the reception response to relaying apparatus 32 (Step S304). Upon receiving the reception response from SMSC 15a, relaying apparatus 32 transmits this reception response (MSG(RP-ACK) (RP-Acknowledge)) to UE (X) 2x by way of IMS 13a (Step S305). UE (X) 2x transmits “200 (OK),” which is an SIP message indicating that the request was successful, to relaying apparatus 32 by way of IMS 13a (Step S306).

In addition, upon receiving the MAP-MOforwardSM, SMSC 15a transmits MAP-SRI (Send Routing Information) forSM that requests routing information of the SMS message, to HLR/HSS 14b in which UE (Z) 2z is positionally registered (Step S307). HLR/HSS 14b, having received the MAP-SRIforSM from SMSC 15a, transmits a reception response that contains the routing information to SMSC 15a (Step S308).

SMSC 15a, having received the routing information from HLR/HSS 14b, transmits to IPSMGW 16 a MAP-MT (Mobile Terminated) forwardSM for distributing the SMS message to UE (Z) 2z (Step S309). IPSMGW 16 transmits the SMS message distributed from SMSC 15a to UE (Z) 2z by Short Message Service Relay Protocol (Step S310). More specifically, IPSMGW 16 generates a MSG (RP-MT-DATA) (Short Message Relay Layer Protocol Terminated) that is a message made up in the format shown in FIG. 15 and transmits this message to UE (Z) 2z by way of IMS 13b. When the message is here being sent in the “Push” form, the message is immediately transmitted to UE (Z) 2z that is the transmission destination, and UE (Z) 2z returns the reception response to IPSMGW 16. On the other hand, when the message is being transmitted in the “Pull” form, IPSMGW 16 transmits the message to UE (Z) 2z in accordance with a request to transmit the message from UE (Z) 2z.

Upon completing the distribution of the SMS message, IPSMGW 16 transmits a message indicating this completion to SMSC 15a (Step S311).

When UE (X) 2x transmits a message to UE (Z) 2z by way of server 31 as shown in FIG. 21, UE (X) 2x generates a message made up in the format shown in FIG. 12 and transmits this message to server 31 (Step S401). Server 31 transmits this message to relaying apparatus 32 based on the set value of the Dst.Address portion of the message received from UE (X) 2x (Step S402).

Relaying apparatus 32, upon receiving the message that takes UE (Z) 2z as the transmission destination from server 31, transmits MAP-MOforwardSM, which is a message made up from the format shown in FIG. 11, to SMSC 15a (Step S403).

SMSC 15a, upon receiving the MAP-MOforwardSM, transmits a reception response to this message to relaying apparatus (Step S404). Relaying apparatus 32, having received the reception response from SMSC 15a, transmits the reception response to server 31 (Step S405). Server 31 transfers this reception response to UE (X) 2x (Step S406).

SMSC 15a subsequently, similarly to the operation shown in FIG. 20, transmits MAP-SRIforSM that requests routing information of the SMS message to HLR/HSS 14b in which UE (Z) 2z is positionally registered (Step S307) and acquires the routing information from HLR/HSS 14b (Step S308).

Upon acquiring the routing information from HLR/HSS 14b, SMSC 15a transmits MAP-MTforwardSM for distributing the SMS message to UE (Z) 2z to IPSMGW 16 on the basis of this routing information (Step S309). IPSMGW 16 transmits the SMS message that was distributed from SMSC 15a to UE (Z) 2z by Short Message Service Relay protocol (Step S310).

Upon completion of the distribution of the SMS message, IPSMGW 16 transmits a message indicating this completion to SMSC 15a (Step S311).

When transmitting a message from UE (Z) 2z to UE (X) 2x by way of portable telephone networks 10B and 10A as shown in FIG. 22, UE (Z) 2z generates MSG (RP-MO-DATA) that is made up of a format similar to the format shown in FIG. 10 and transmits this MSG (RP-MO-DATA) to IPSMGW 16 by way of IMS 13b (Step S501).

As described above, the Header portion of the TPDU portion is set to “Deliver” and the Dst.Address portion is set to the portable telephone number of UE (X) 2x in the MSG (RP-MO-DATA) that is transmitted from UE (Z) 2z. In addition, the Org.Address portion of the TPDU portion is set to the portable telephone number of UE (Z) 2z, and the Dst.Address portion of the TPDU portion is “unset (−).”

Upon receiving MSG (RP-MO-DATA) that takes UE (X) 2x as the transmission destination from IMS 13b, IPSMGW 16 returns a reception response to UE (Z) 2z by way of IMS 13b (Step S502). In addition, IPSMGW 16 transmits MAP-MOforwardSM that is a message made up in the format shown in FIG. 15 to SMSC 15b (Step S503).

Upon receiving MAP-MOforwardSM, SMSC 15a returns a reception response to IPSMGW 16 (Step S504). Upon receiving the reception response from SMSC 15b, IPSMGW 16 transmits a reception response to UE (Z) 2z by way of IMS 13b (Step S505). Upon completing the transmission of the SMS message, UE (Z) 2z transmits a message indicating this completion to SMSC 15b by way of IMS 13b (Step S506).

In addition, upon receiving MAP-MOforwardSM, SMSC 15b transmits MAP-SRI (Send Routing Information) forSM that requests routing information of the SMS message to HLR/HSS 14a in which UE (X) 2x is positionally registered (Step S507). Upon receiving the MAP-SRIforSM from SMSC 15b, HLR/HSS 14a transmits a reception response that includes the routing information to SMSC 15b (Step S508).

Upon acquiring the routing information from HLR/HSS 14a, SMSC 15b transmits MAP-MTforwardSM for distributing the SMS message to UE (X) 2x on the basis of the routing information to relaying apparatus 32 (Step S509). Relaying apparatus 32 transmits the SMS message that was distributed from SMSC 15b to UE (X) 2x in Short Message Service Relay Protocol (Step S510). More specifically, relaying apparatus 32 generates MSG (RP-MT-DATA) that is a message made up from the format shown in FIG. 16 and transmits the message to UE (X) 2x by way of IMS 13a.

Upon receiving MSG (RP-MT-DATA) from IMS 13a, UE (X) 2x returns “202 (Accepted)” that is an SIP message indicating that the request has been received but that the process has not been completed to relaying apparatus 32 by way of IMS 13a (Step S511). Further, when UE (X) 2x receives MSG (RP-MT-DATA), UE (X) 2x returns the reception response (MSG(RP-ACK)) to relaying apparatus 32 (Step S512).

Relaying apparatus 32, having received MSG(RP-ACK), transmits “200 (OK)” that is an SIP message indicating that the request has succeeded to UE (X) 2x by way of IMS 13a (Step S513). Finally, upon completion of the distribution of the SMS message, relaying apparatus 32 transmits a message indicating this completion to SMSC 15b (Step S514).

When a message is transmitted from UE (Z) 2z to UE (X) 2x by way of server 31 as shown in FIG. 23, similarly to the operation shown in FIG. 22, UE (Z) 2z generates MSG (RP-MO-DATA) that is composed in the format shown in FIG. 10 and transmits this MSG (RP-MO-DATA) to IPSMGW 16 by way of IMS 13b (Step S501). Upon receiving MSG (RP-MO-DATA) that takes UE (X) 2x as the transmission destination from IMS 13b, IPSMGW 16 returns a reception response to UE (Z) 2z by way of IMS 13b (Step S502). In addition, IPSMGW 16 transmits a MAP-MOforwardSM that is a message made up in the format shown in FIG. 15 SMSC 15b (Step S503).

Upon receiving the MAP-MOforwardSM, SMSC 15b returns a reception response to IPSMGW 16 (Step S504). Upon receiving the reception response from SMSC 15b, IPSMGW 16 transmits the reception response to UE (Z) 2z by way of IMS 13b (Step S505). UE (Z) 2z, upon completion of the transmission of the SMS message, transmits a message indicating this completion to SMSC 15b by way of IMS 13b (Step S506). Further, when SMSC 15b receives MAP-MOforwardSM, SMSC 15a transmits MAP-SRI (Send Routing Information) forSM that requests routing information of the SMS message to HLR/HSS 14a in which UE (X) 2x is positionally registered (Step S507). HLR/HSS 14a, having received MAP-SRIforSM from SMSC 15b, transmits a reception response that contains the routing information to SMSC 15b (Step S508).

Upon acquiring the routing information from HLR/HSS 14a, SMSC 15b transmits MAP-MTforwardSM for distributing the SMS message to UE (X) 2x on the basis of the routing information (Step S509).

Relaying apparatus 32 converts the SMS message that was distributed from SMSC 15b to a message of the format shown in FIG. 17 and transmits this message after conversion to server 31 (Step S601). Server 31 transmits this message to UE (X) 2x based on the set value of the Dst.Address portion of the message that was received from relaying apparatus 32.

When the message is to be transmitted by the “Push” form, server 31 immediately transmits the message to UE (X) 2x that is the transmission destination (Step S602) and UE (X) 2x returns a reception response to this transmission to server 31 (Step S603). On the other hand, when the message is to be transmitted in the “Pull” form, server 31, in accordance with a transmission request from UE (X) 2x (Step S604), transmits the message to UE (X) 2x (Step S605).

Upon completion of the distribution of the SMS message, server 31 transmits a message indicating this completion to relaying apparatus (Step S606), and relaying apparatus 32 transmits this message to SMSC 15b (Step S607).

In the present invention as described above, a network that includes portable telephone network 10A and IP network 20 that is not a portable telephone network is provided with relaying apparatus 32 that is provided with both the functions of IPSMGW 16 and the functions of a gateway that switches the distribution path to IP network 20 when messages are transmitted and received by way of server 31. As a result, UE 2 that is able to connect to portable telephone network 10A or to IP network 20 that is not a portable telephone network is able to transmit and receive messages by way of IP network 20 even when unable to connect to portable telephone network 10A. As a result, the occurrence of a communication problem in which messages cannot be transmitted or received can be reduced.

In addition, relaying apparatus 32 is arranged between SMSC 15 and IMS 13 similar to IPSMGW 16 in portable telephone network 10B. As a result, messages can be transmitted and received with UE 2 that, without the mediation of IMS 13, can connect to portable telephone network 10A and UE 2 that cannot connect to portable telephone network 10A.

Still further, for IMS 13, HLR/HSS 14, and SMSC 15, relaying apparatus 32 appears similar to existing IPSMGW 16. As a result, improvements of already established nodes such as IMS 13 HLR/HSS 14 and SMSC 15 are unnecessary, and the negative impact upon an existing communication system can thus be reduced.

The method that is executed at each node of the present invention may be executed by a computer that executes processing in accordance with a program. This program can also be stored in a storage medium or can be provided to the outside by way of a network.

Although the invention of the present application has been described with reference to an exemplary embodiment, the invention of the present application is not limited to the above-described exemplary embodiment. The configuration and details of the invention of the present application are open to various modifications within the scope of the invention of the present application that will be clear to one of ordinary skill in the art.

This application is based upon and claims the benefit of priority from Japanese Patent Application No. 2015-197321, filed on Oct. 5, 2015, the disclosure of which is incorporated herein in its entirety by reference.

1. A communication system comprising:
a service control device that is provided in a first network in which user terminals perform communication by way of a wireless base station and that distributes messages to said user terminals;
a server that is provided in a second network that differs from said first network and that transmits and receives said messages with said user terminals by way of said second network in which said user terminals communicate without the mediation of said wireless base station; and a relaying apparatus that is connected to said service control device and that relays messages that are transmitted and received between user terminals in said first network as well as messages that are transmitted and received between user terminals in said first network and user terminals in said second network.

2. The communication system according to claim 1, wherein:
a user terminal in said second network, when transmitting a message that takes a user terminal in said first network as the transmission destination, transmits a message in which a user-name for identifying its own user terminal is set as the transmission origin; and
said relaying apparatus, upon receiving a message in which a user terminal in said first network is the transmission destination and a user terminal in said second network is the transmission origin, converts the user-name of the transmission origin of the message to a corresponding telephone number.

3. The communication system according to claim 1 or 2, wherein:
a user terminal in said first network, when transmitting a message that takes a user terminal in said second network as the transmission destination, transmits a message in which the telephone number of the user terminal in said second network that is the transmission destination of the message is set as the transmission destination; and
said relaying apparatus, upon receiving a message that takes a user terminal in said second network as the transmission destination and that takes a user terminal in said first network as the transmission origin, converts the telephone number of the transmission destination of the message to a corresponding user-name.

4. The communication system according to claim 1, wherein:
a user terminal in said second network, when transmitting a message that takes a user terminal in said second network as the transmission destination, transmits a message in which a user-name for identifying its own user terminal is set as the transmission origin and a user-name for identifying a user terminal in said second network that is the transmission destination of the message is set as the transmission destination; and
said server, upon receiving a message that takes a user terminal in said second network as the transmission destination and takes a user terminal in said second network as the transmission origin, transmits the message to the user terminal that corresponds to the user-name of the transmission destination of the message.

5. A relaying apparatus comprising:
a first communication unit that communicates with a service control device that is provided in a first network in which user terminals perform communication by way of a wireless base station and that distributes messages to said user terminals;
a second communication unit that communicates with a server that is provided in a second network that differs from said first network and that transmits and receives said messages with said user terminals by way of said second network in which said user terminals communicate without the mediation of said wireless base station; and
a control unit that relays messages that are transmitted and received between user terminals in said first network by way of said service control device as well as messages that are transmitted and received between user terminals in said first network and user terminals in said second network by way of said service control device.

6. The relaying apparatus as set forth in claim 5, wherein:
said control unit, upon receiving a message that takes a user terminal in said first network as the transmission destination, takes a user terminal in said second network as the transmission origin, and in which a user-name for identifying a user terminal in the second network is set as the transmission origin, converts the user-name of the transmission origin of this message to a corresponding telephone number.

7. The relaying apparatus according to claim 5, wherein:
said control unit, upon receiving a message that takes a user terminal in said second network as the transmission destination, that takes a user terminal in said first network as the transmission origin, and in which a telephone number of a user terminal in said first network is set as the transmission origin, converts the telephone number of the transmission destination of this message to a corresponding user-name.

8. A control method of a relaying apparatus that includes: a first communication unit that communicates with a service control device that is provided in a first network in which user terminals perform communication by way of a wireless base station and that distributes messages to said user terminals; and a second communication unit that communicates with a server that is provided in a second network that differs from said first network and that transmits and receives said messages with said user terminals by way of said second network in which said user terminals communicate without the mediation of said wireless base station; said control method comprising steps of:
relaying messages that are transmitted and received between user terminals in said first network by way of said service control device; and
relaying messages that are transmitted and received between user terminals in said first network and user terminals in said second network by way of said service control device.

9. A non-transitory recording medium that can be read by a computer and on which is recorded a program for causing a computer to execute processes of:
communicating with a service control device that is provided in a first network in which user terminals perform communication by way of a wireless base station and that distributes messages to said user terminals;
communicating with a server that is provided in a second network that differs from said first network and that transmits and receives said messages with said user terminals by way of said second network in which said user terminals communicate without the mediation of said wireless base station;
relaying messages that are transmitted and received among user terminals in said first network by way of said service control device; and
relaying messages that are transmitted and received between user terminals in said first network and user terminals in said second network by way of said service control device.
